(19) United States
(12) Patent Application Publication
(10) Pub. No.: US 2026/0171553 A1
(43) Pub. Date: Jun. 18, 2026

(54) SOLID OXIDE CELL

(71) Applicant: SAMSUNG ELECTRO-MECHANICS CO., LTD., Suwon-si (KR)

(72) Inventors: A Reum JUN, Suwon-si (KR); Bon Seok KOO, Suwon-si (KR); Su Beom PARK, Suwon-si (KR); Jae Seok YI, Suwon-si (KR); Sung Kwon AN, Suwon-si (KR); Yoon A JANG, Suwon-si (KR)

(73) Assignee: SAMSUNG ELECTRO-MECHANICS CO., LTD., Suwon-si (KR)

(21) Appl. No.: 19/323,054

(22) Filed: Sep. 9, 2025

(30) Foreign Application Priority Data
Dec. 13, 2024 (KR) 10-2024-0186149

(51) Int. Cl. H01M 12/06; H01M 4/90

(52) U.S. Cl. CPC H01M 12/06; H01M 4/9025; H01M 4/905

(57) ABSTRACT

A solid oxide cell includes a fuel electrode, an air electrode, and an electrolyte disposed between the fuel electrode and the air electrode, in which the fuel electrode includes an electron-conductive needle-shaped particle, and the needle-shaped particle includes an Fe-Ni-based alloy. A length of a major axis of the needle-shaped particle may be at least 1.5 times a length of a minor axis of the needle-shaped particle.

### CROSS-REFERENCE TO RELATED APPLICATION(S)

This patent document claims the priority and benefits of Korean Patent Application No. 10-2024-0186149 filed on Dec. 13, 2024, the disclosure of which is incorporated herein by reference in its entirety.

### TECHNICAL FIELD

The present disclosure relates to a solid oxide cell.

A solid oxide fuel cell (SOFC) and a solid oxide electrolysis cell (SOEC) include a cell composed of an air electrode, a fuel electrode, and a solid electrolyte having oxygen ion conductivity, in which the cell may be referred to as a solid oxide cell. The solid oxide cell produces electrical energy through an electrochemical reaction or produces hydrogen by electrolyzing water through a reverse reaction of the solid oxide fuel cell. Compared to other types of fuel cells or water electrolysis cells, such as a phosphoric acid fuel cell (PAFC), an alkaline fuel cell (AFC), a polymer electrolyte fuel cell (PEMFC), and a direct methanol fuel cell (DMFC), the solid oxide cell has low overvoltage and low irreversible loss due to having low activation polarization, leading to high efficiency. In addition, the solid oxide cell has a wide range of fuel options as it may use not only hydrogen but also carbon or hydrocarbon-based fuels, and has the advantage of not requiring expensive precious metals as electrode catalysts because the reaction rate at the electrode is high.

The solid oxide cell generally has a structure in which an electrolyte is disposed between electrode layers, and the reaction that allows the solid oxide cell to function as a battery occurs in the electrode layers. In the field of technology, there is a need for a method to improve reaction efficiency in these electrode layers.

### SUMMARY

An aspect of the present disclosure is to realize a solid oxide cell having an electrode layer with improved reactivity.

According to an aspect of the present disclosure, a solid oxide cell includes a fuel electrode, an air electrode, and an electrolyte disposed between the fuel electrode and the air electrode, in which the fuel electrode includes an electron-conductive needle-shaped particle, and the needle-shaped particle includes an Fe—Ni-based alloy.

Based on a cross-section of the fuel electrode, a length of a major axis of the needle-shaped particle may be at least 1.5 times a length of a minor axis.

The electron-conductive needle-shaped particle includes a plurality of electron-conductive needle-shaped particles, and based on a cross-section of the fuel electrode, a length of a major axis and a length of a minor axis may be an average length of the major axis and an average length of the minor axis, respectively, of the plurality of needle-shaped particles.

The fuel electrode may include a fuel electrode support, and a fuel electrode functional layer disposed between the electrolyte and the fuel electrode support.

The fuel electrode functional layer may include the needle-shaped particle.

In the Fe—Ni-based alloy, a content ratio of Fe to Ni may be 1 wt % to 15 wt %.

The fuel electrode may further include an ion conductor.

The ion conductor may include at least one of gadolinia-doped ceria (GDC), samaria-doped ceria (SDC), yttria-doped ceria (YDC), scandia-stabilized zirconia (SSZ), or ytterbia-ceria-scandia-stabilized zirconia (YbCSSZ).

The ion conductor may be in contact with the needle-shaped particle.

The fuel electrode may further include an electron-conductive spherical particle.

The spherical particle may include the Fe—Ni-based alloy.

The spherical particle may include a Ni-based alloy.

The fuel electrode may further include a needle-shaped particle including a Ni-based alloy that is different from the Fe—Ni-based alloy.

The ion conductor may include yttria-stabilized zirconia.

The ion conductor may include at least one of doped ceria, doped zirconia, doped lanthanum gallate, or doped bismuth oxide.

The ion conductor may include doped zirconia.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a solid oxide cell according to an example embodiment of the present disclosure;

FIG. 2 is a cross-sectional view schematically illustrating one region of the solid oxide cell;

FIG. 3 is an enlarged view of one region of the fuel electrode;

FIG. 4 is an enlarged view of one region of an electrolyte;

FIG. 5 is an enlarged view of one region of an air electrode;

FIG. 6 is a cross-sectional view schematically illustrating one region of a needle-shaped particle;

FIG. 7 is a cross-sectional view schematically illustrating one region of a solid oxide cell according to a modified example;

FIG. 8 is an enlarged view of one region of the fuel electrode; and

FIG. 9 is a graph showing performance of solid oxide cells manufactured according to an example embodiment and a comparative example of the present disclosure.

### DETAILED DESCRIPTION

Hereinafter, example embodiments will be described in detail with reference to the accompanying drawings. However, example embodiments may be modified in various other forms, and the scope of the present disclosure is not limited to example embodiments to be described below. Further, example embodiments are provided in order to more completely describe the present disclosure to those skilled in the art. In the drawings, the shapes and dimensions may be exaggerated for clarity, and the same reference numerals will be used throughout to designate the same or like components.

In order to clearly describe the present disclosure in the drawings, parts that are not related to the description are omitted, and the thickness is enlarged to clearly express various layers and areas, and components with the same function within the scope of the same idea are described using the same reference numerals. Furthermore, throughout the present specification, unless explicitly described to the contrary, “comprising” any components will be understood to imply the inclusion of other elements rather than the exclusion of any other elements.

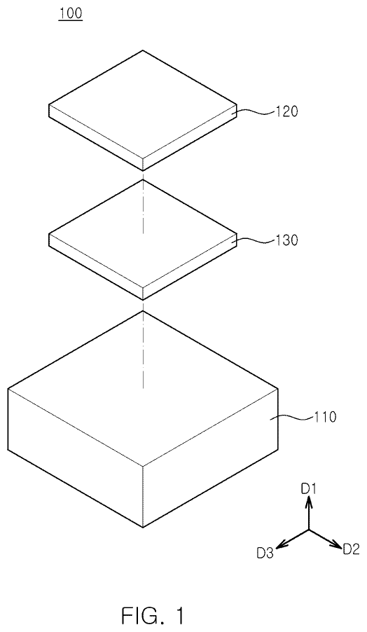

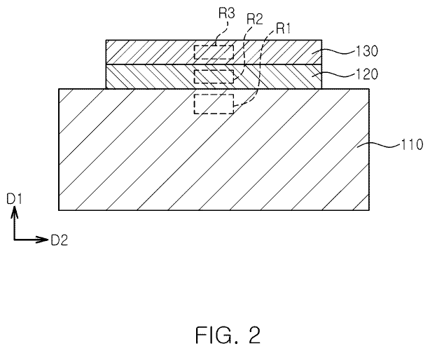

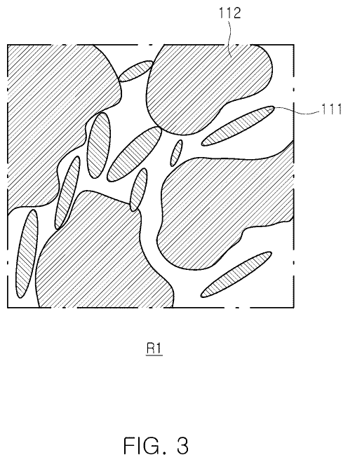

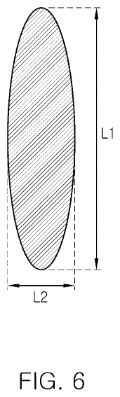

FIG. 1 is a perspective view schematically illustrating a solid oxide cell according to an example embodiment of the present disclosure. FIG. 2 is a cross-sectional view schematically illustrating one region of the solid oxide cell. FIGS. 3 through 5 are enlarged views of regions of a fuel electrode, an electrolyte, and an air electrode, respectively. FIG. 6 is a cross-sectional view schematically illustrating one region of a needle-shaped particle.

First, referring to FIGS. 1 through 5, a solid oxide cell 100 according to an example embodiment of the present disclosure includes a fuel electrode 110, an air electrode 130, and an electrolyte 120 disposed between the fuel electrode 110 and the air electrode 130 as main components. Here, the fuel electrode 110 includes electron-conductive needle-shaped particles 111, and the needle-shaped particles 111 include an Fe—Ni-based alloy. By implementing electron-conductive particles using the Fe—Ni-based alloy, activity of a catalyst may be improved compared to when Ni is used alone. In addition, by forming the Fe—Ni-based alloy into the needle-shaped particles 111, a contact area with the ion conductor 112 within the fuel electrode 110 is increased, and the reactivity and catalytic activity of the fuel electrode 110 may be improved. Accordingly, the performance of the solid oxide cell 100 may be improved, and for example, when used as a water electrolysis cell, a current density may be improved within the same voltage.

Hereinafter, the components of the solid oxide cell 100 will be described in detail. The solid oxide cell 100 may be used as both a fuel cell and a water electrolysis cell, and in the case of the water electrolysis cell mode, a reaction opposite to that in the case of the fuel cell will occur at the fuel electrode 110 and air electrode 130 of the solid oxide cell 120. Specifically, when the solid oxide cell 100 is a fuel cell, for example, water generation or an oxidation reaction of a carbon compound due to the oxidation of hydrogen may occur at the fuel electrode 110, and an oxygen ion generation reaction due to the decomposition of oxygen may occur at the air electrode 130. When the solid oxide cell 100 is the water electrolysis cell, a reaction opposite thereto may occur, and for example, hydrogen gas may be generated at the fuel electrode 110 due to the reduction reaction of water, and oxygen may be generated at the air electrode 130. In addition, as another example, in the case of the fuel cell, a decomposition reaction (hydrogen ion generation) of hydrogen may occur at the fuel electrode 110, and oxygen and hydrogen ions may combine at the air electrode 130 to generate water. In the case of the water electrolysis cell, a decomposition reaction (hydrogen and oxygen ion generation) of water may occur at the fuel electrode 110, and oxygen may be generated at the air electrode 130. In addition, ions may move to the fuel electrode 110 or the air electrode 130 in the electrolyte 120.

Describing in detail the materials constituting the fuel electrode 110, the electrolyte 120, and the air electrode 130, first, as in the form illustrated in FIG. 3, the fuel electrode 110 may include the electron-conductive needle-shaped particles 111 and the ion conductor 112, and in this case, the ion conductor 112 may come into contact with the needle-shaped particles 111. As described above, the needle-shaped particles 111 may perform an electrically conductive function and a catalytic function, and includes the Fe—Ni-based alloy. Here, the content of Fe in the Fe—Ni-based alloy may be adjusted within a range that may increase the catalytic activity of Ni, and according to the research of the present inventors, the content ratio of Fe to the content of Ni in the Fe—Ni-based alloy may be 1 wt % to 15 wt %. In this case, the content of each element in the Fe—Ni-based alloy may be found out by analyzing the cross-section of the solid oxide cell 100, and for example, the content of each element may be obtained through ICP-TEM analysis. When a molar ratio of each element is obtained, it may be converted into wt %, and this cross-section analysis may be a method of deriving an average value by analyzing multiple regions of a cross-section, or further, multiple cross-sections. Other methods and/or tools appreciated by one of ordinary skill in the art, even if not described in the present disclosure, may also be used.

As described above, when using the needle-shaped particles 111 as the electronic conductive particles including the Fe—Ni-based alloy, the contact area with the ion conductor 112 within the fuel electrode 110 may be increased. Here, with respect to the shape of the needle-shaped particles 111, it may be defined as a shape in which lengths of a major axis and a minor axis are different. As a more specific example, referring to FIG. 6, based on a cross-section of the fuel electrode 110, a length L1 of the major axis of the needle-shaped particles 111 may be 1.5 times or more a length L2 of the minor axis. In this case, as illustrated in FIG. 3, when there are multiple needle-shaped particles 111 in a cross-section of the fuel electrode 110, the length L1 of the major axis and the length L2 of the minor axis may be an average length of the multiple needle-shaped particles 111. L1 and L2 may be measured from an image observed by using, for example, a scanning electron microscope (SEM), a transmission electron microscope (TEM), a scanning transmission electron microscope (STEM), or a field emission-scanning electron microscope (FE-SEM). Other methods and/or tools appreciated by one of ordinary skill in the art, even if not described in the present disclosure, may also be used.

As another component of the fuel electrode 110, the ion conductor 112 may include materials such as yttria-stabilized zirconia-based (YSZ) material, ceria-based (CeO₂) material, bismuth oxide-based (Bi₂O₃) material, or lanthanum gallate-based (LaGaO₃) material. In addition, the fuel electrode 110 may be a porous body including random pores H1 having random shapes and arrangements. The pores H1 of the fuel electrode 110 may be formed by adding a polymer-based pore forming agent during the manufacture of the fuel electrode 110 and then removing the pores by heat treatment, and tend to have high tortuosity and small diameters.

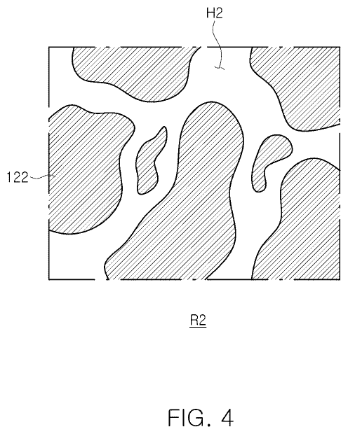

Referring to FIG. 4, the electrolyte 120 may be a sintered body of particles. The electrolyte 120 may be a porous body including pores H2, through which gas, fluid, etc., may pass. The electrolyte 120 may include an ion conductor 122, and an example of a material constituting the ion conductor 122 may include stabilized zirconia. Specifically, the ion conductor 122 may include smaydia-stabilized zirconia (SSZ), yttria-stabilized zirconia (YSZ), smaydia-ceria-stabilized zirconia (SCSZ), smaydia-ceria-yttria-stabilized zirconia (SCYSZ), smaydia-ceria-ytterbia-stabilized zirconia (SCYbSZ), etc.

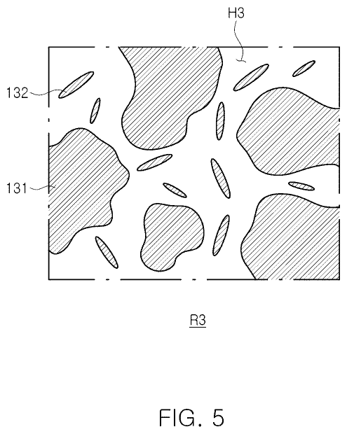

Referring to FIG. 5, the air electrode 130 may include an electronic conductor 131 and an ion conductor 132, which may be a sintered body of particles. In the air electrode 130, the electron conductor 131 may include an electrically conductive material, such as an electrically conductive perovskite material such as lanthanum strontium manganite (LSM). Other conductive perovskites, such as lanthanum strontium cobalt (LSC), lanthanum strontium cobalt manganese (LSCM), lanthanum strontium cobalt ferrite (LSCF), lanthanum strontium ferrite (LSF), La_{0.85}Sr_{0.15}Cr_{0.9}Ni_{0.1}O₃ (LSCN), or a metal such as Pt, may also be used. The ion conductor 132 may include materials such as yttria-stabilized zirconia-based (YSZ) material, ceria-based (CeO₂) material, bismuth oxide-based (Bi₂O₃) material, or lanthanum gallate-based (LaGaO₃) material. The air electrode 130 may include about 10 wt % to about 90 wt % of electronic conductor 131 and about 10 wt % to about 90 wt % of ion conductor 132, but according to the example embodiment, the air electrode 130 may not include the ion conductor 132. As in the illustrated form, the air electrode 130 may be a porous body including pores H3, through which a gas, a fluid, etc., may pass.

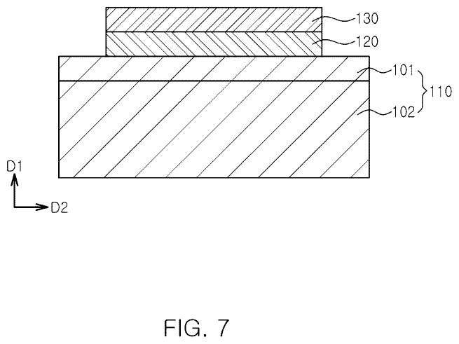

Meanwhile, in the case of the solid oxide cell 100 according to the present example embodiment, the electrolyte 120 and the air electrode 130 may be a fuel electrode-supported structure supported by the fuel electrode 110. In the case of such a fuel electrode-supported solid oxide cell 100, since the thickness of the electrolyte 120 is relatively thin, the resistance to ion movement may be reduced, so that the output density may be improved. As a more specific example, as in the example embodiment of FIG. 7, the fuel electrode 110 may include a fuel electrode support 102 and a fuel electrode functional layer 101 disposed between the electrolyte 120 and the fuel electrode support 102. In this case, the needle-shaped particles 111 including the Fe—Ni-based alloy having high reaction efficiency may be included in the fuel electrode functional layer 101 close to the electrolyte 120. In this case, the needle-shaped particles 111 may not be included in the fuel electrode support 102. However, the needle-shaped particles 111 may be partially included in the fuel electrode support 102 or may be included in the fuel electrode support 102 in an amount equivalent to that of the fuel electrode functional layer 101 in order to further improve the reactivity.

Meanwhile, an example of a process for manufacturing the solid oxide cell centered on a method for manufacturing a fuel electrode 110 including the fuel electrode functional layer 101 will be described. After preparing the fuel electrode support 102 in a green sheet state, slurry for a fuel electrode functional layer is applied thereon. Specifically, Ni oxide powder, Fe oxide powder, and ion conductor powder (YSZ) are mixed with a solvent, a binder, and a plasticizer to produce slurry. Then, the slurry is made into a sheet shape using a method such as tape casting, and applied onto the fuel electrode support 102 in the green sheet state. Thereafter, an electrolyte sheet is formed and fired at a high temperature, and the solid oxide cell may be obtained through the formation and firing process of an air electrode sheet in addition to the method. As powders are reduced in the above-described firing process of the fuel electrode, an alloy of Ni and Fe may be obtained.

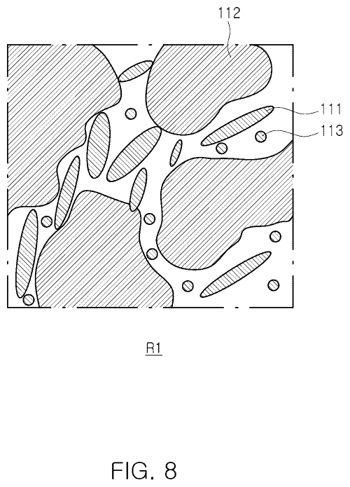

Although the above-described embodiment shows a case where only the needle-shaped particles 111 exist in the fuel electrode 110, particles of other shapes besides the needle-shaped particles 111 may also be included. Referring to the modified example of FIG. 8, the fuel electrode may further include electron-conductive spherical particles 113. In this case, the spherical particles 113 may include the Fe-Ni-based alloy, for example, the Fe—Ni-based alloy having substantially the same composition as the needle-shaped particles 111. In contrast, the spherical particles 113 may include a Ni-based alloy, and further, may include both the Fe-Ni-based alloy and the Ni-based alloy. In addition, the needle-shaped particles 111 may also include a material other than the Fe-Ni-based alloy, for example, the fuel electrode may further include the needle-shaped particles 111 including the Ni-based alloy. In this way, the materials constituting the needle-shaped particles 111 and the spherical particles 113 may be appropriately added to the Fe—Ni-based alloy as needed.

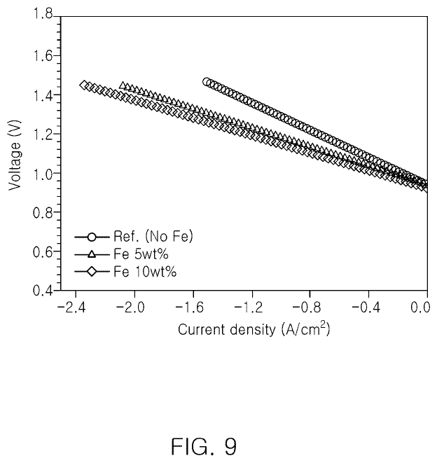

FIG. 9 is a graph showing performance of solid oxide cells manufactured according to an example embodiment and a comparative example of the present disclosure. Specifically, the current density according to the voltage applied to the electrolysis cell (700° C., 80% H₂O and 20% H₂ conditions) was measured by changing the materials included in the electrically conductive particles of the fuel electrode. In the case of the related art (Ref.), Ni without Fe was used, and in the example embodiments of the present disclosure, the Fe content was varied to 5 wt % and 10 wt % relative to Ni and the experiment was conducted. According to the experimental results of FIG. 9, the current density was improved at the same voltage when the Fe—Ni-based alloy was used as the electron conductor compared to the case where Fe was not added. In addition, when the Fe content was at a level of 10 wt %, the current density was further improved as the Fe content increased. It was confirmed that when Fe is added at a level of 10 wt %, an improvement of approximately 60% in terms of current density may be observed compared to when Fe is not added.

According to the solid oxide cell according to an example of the present disclosure, it is possible to improve the reactivity of the electrode layer, particularly, the fuel electrode. Therefore, it is possible to improve the performance of the solid oxide cell when the solid oxide cell is used as the fuel cell or the water electrolysis cell.

While example embodiments have been shown and described above, it will be apparent to those skilled in the art that modifications and variations could be made without departing from the scope of the present invention as defined by the appended claims.

What is claimed is:

1. A solid oxide cell, comprising:
a fuel electrode;
an air electrode; and
an electrolyte disposed between the fuel electrode and the air electrode,
wherein the fuel electrode includes an electron-conductive needle-shaped particle, and the needle-shaped particle includes an Fe—Ni-based alloy.

2. The solid oxide cell according to claim 1, wherein, based on a cross-section of the fuel electrode, a length of a major axis of the needle-shaped particle is at least 1.5 times a length of a minor axis.

3. The solid oxide cell according to claim 1, wherein, the electron-conductive needle-shaped particle includes a plurality of electron-conductive needle-shaped particles, and based on a cross-section of the fuel electrode, a length of a major axis and a length of a minor axis are an average length of the major axis and an average length of the minor axis, respectively, of the plurality of needle-shaped particles.

4. The solid oxide cell according to claim 1, wherein the fuel electrode includes a fuel electrode support, and a fuel electrode functional layer disposed between the electrolyte and the fuel electrode support.

5. The solid oxide cell according to claim 4, wherein the fuel electrode functional layer includes the needle-shaped particle.

6. The solid oxide cell according to claim 1, wherein, in the Fe—Ni-based alloy, a content ratio of Fe to Ni is 1 wt % to 15 wt %.

7. The solid oxide cell according to claim 1, wherein the fuel electrode further includes an ion conductor.

8. The solid oxide cell according to claim 7, wherein the ion conductor includes at least one of gadolinia-doped ceria (GDC), samaria-doped ceria (SDC), yttria-doped ceria (YDC), scandia-stabilized zirconia (SSZ), or ytterbia-ceria-scandia-stabilized zirconia (YbCSSZ).

9. The solid oxide cell according to claim 8, wherein the ion conductor is in contact with the needle-shaped particle.

10. The solid oxide cell according to claim 1, wherein the fuel electrode further includes an electron-conductive spherical particle.

11. The solid oxide cell according to claim 10, wherein the spherical particle includes the Fe-Ni-based alloy.

12. The solid oxide cell according to claim 10, wherein the spherical particle includes a Ni-based alloy.

13. The solid oxide cell according to claim 1, wherein the fuel electrode further includes a needle-shaped particle including a Ni-based alloy that is different from the Fe—Ni-based alloy.

14. The solid oxide cell according to claim 7, wherein the ion conductor includes yttria-stabilized zirconia.

15. The solid oxide cell according to claim 7, wherein the ion conductor includes at least one of doped ceria, doped zirconia, doped lanthanum gallate, or doped bismuth oxide.

16. The solid oxide cell according to claim 15, wherein the ion conductor includes doped zirconia.
